(19) United States
(12) Patent Application Publication
(10) Pub. No.: US 2025/0289427 A1
(43) Pub. Date: Sep. 18, 2025

(54) Method for Adjusting a Target Distance Between a Motor Vehicle and a Preceding Vehicle Traveling in Front, Computer Program, Control Device, and Motor Vehicle

(71) Applicant: Bayerische Motoren Werke Aktiengesellschaft, Muenchen (DE)

(72) Inventors: Philip AVDIMETAJ, Aschau (DE); Christian SCHWALBACH, Muenchen (DE)

(21) Appl. No.: 18/860,514

(22) PCT Filed: Apr. 20, 2023
(86) PCT No.: PCT/EP2023/060331

§ 371 Date: Oct. 25, 2024

(30) Foreign Application Priority Data
Apr. 27, 2022 (DE) 10 2022 110 269.6

(51) Int. Cl. B60W 30/165; B60W 30/14

(52) U.S. Cl. CPC B60W 30/165; B60W 30/143; B60W 2420/403; B60W 2420/408; B60W 2520/10; B60W 2552/10; B60W 2554/402; B60W 2554/802

(57) ABSTRACT

A method for adjusting a target distance between a motor vehicle and a preceding vehicle traveling in front includes activating an adaptive cruise control to adjust the target distance. The method includes determining distance information characterizing the distance between the motor vehicle and the preceding vehicle. The method includes determining vehicle type information characterizing a vehicle type of the preceding vehicle. The method includes determining a correction distance on the basis of the distance information and the vehicle type information. The method includes adjusting the target distance on the basis of the correction distance.

### BACKGROUND AND SUMMARY

The present invention relates to a method for adjusting a target distance between a motor vehicle and a preceding vehicle traveling in front, and a data processing device designed to at least partially carry out the method. Furthermore, an automated motor vehicle having the data processing device is provided. Additionally, or alternatively, a computer program is provided that comprises commands which, upon the execution of the program by a computer, prompt it to at least partially carry out the method. Additionally, or alternatively, a computer-readable medium is provided that comprises commands which, upon the execution of the commands by a computer, prompt it to at least partially carry out the method.

Methods for adjusting a target distance are known from the prior art. DE 10 2017 213 278 A1 discloses a method for the dynamic and situation-specific adjustment of a target distance between two vehicles using a data service. Reading out a data service to provide route parameters and adjust the target distance in dependence on the provided route parameters is provided here. The target distance can therefore be adjusted without manual action.

However, it can be necessary from the viewpoint of the driver, thus for subjective reasons, and/or for technical reasons to adjust the target distance.

Against the background of this prior art, the object of the present invention is to specify a method which is capable of meeting at least the above-mentioned requirement and enabling an adjustment of the target distance.

The object is achieved by the features of the independent claim. The dependent claims have preferred refinements of the invention as the content.

Accordingly, the object is achieved by a method for adjusting a target distance between a motor vehicle and a preceding vehicle traveling in front. The method comprises the following steps: activating an adaptive cruise control to adjust the target distance, determining distance information characterizing the distance between the motor vehicle and the preceding vehicle; determining vehicle type information characterizing a vehicle type of the preceding vehicle; determining a correction distance on the basis of the distance information and the vehicle type information; and adjusting the target distance on the basis of the correction distance.

The preceding vehicle is a motor vehicle located in front of the motor vehicle in a direction of travel of the motor vehicle and/or on a lane traveled by the motor vehicle. The adaptive cruise control regulates the distance between the motor vehicle and the preceding vehicle in order to adjust the distance according to the target distance. The adaptive cruise control makes use of the determined distance. The target distance can be set by the user and/or automatically. The target distance is adjusted by a difference corresponding to the correction distance.

The correction is used for the automated adjustment of the target distance in order to prevent driving too close to the preceding vehicle with a specific vehicle type, which is possibly perceived as unpleasant in particular from the viewpoint of the driver, and to compensate for errors possibly caused by the vehicle type in the detection of the distance between the motor vehicle and the preceding vehicle. The target distance is corrected by the correction distance in dependence on the vehicle type here.

It has been recognized that the target distance has to be corrected in dependence on the vehicle type of the preceding vehicle. For example, driving too close to the preceding vehicle can result in an unpleasant feeling of a driver and/or passenger of the motor vehicle due to an error in the determined distance, and/or can cause the motor vehicle to be subjected, for example, to an elevated risk of rock strike due to the preceding vehicle. A distance which is selected to be excessively large can encourage other road users to merge between the motor vehicle and the preceding vehicle and thus slow down the motor vehicle.

The adjustment of the target distance can take place in such a way that the target distance is increased if the vehicle type of the preceding vehicle is a utility vehicle. In particular in the case of a utility vehicle, the determination of the distance between the motor vehicle and the preceding vehicle can be subject to an error, since a distance detection device, for example, a radar device, of the motor vehicle possibly detects the distance between the motor vehicle and a rear axle of the utility vehicle and not the distance between the motor vehicle and a rear bumper of the utility vehicle, wherein the rear bumper defines the actual distance between the motor vehicle and the utility vehicle. Therefore, it can occur according to the prior art that the motor vehicle drives up too close to the utility vehicle. In this embodiment, the target distance to be adjusted is increased in order to compensate for an error in the distance detection.

The determination of the correction distance and/or the adjustment of the target distance can be dependent on a speed of the motor vehicle. In this embodiment, the traffic events can effectively be taken into consideration. For example, the speed of the motor vehicle can give information about whether the motor vehicle is possibly located on a freeway, on a quiet residential street, and/or at a traffic jam, and whether and how the target distance has to be corrected.

The determination of the correction distance and/or the adjustment of the target distance can be activated above an upper speed threshold and deactivated below a lower speed threshold. The upper speed threshold is greater than the lower speed threshold here. In this embodiment, a hysteresis is achieved with respect to the correction of the target distance in dependence on the speed. The robustness of the correction is thus improved and an unnecessary correction of the target speed is avoided.

The determination of the correction distance and/or the adjustment of the target distance can be dependent on a number of lanes of a road traveled by the motor vehicle. It is therefore possible to take road data into consideration. The number of lanes can be the number of lanes in the direction of travel of the motor vehicle here.

The determination of the correction distance and/or the adjustment of the target distance can be deactivated on a road having multiple lanes. Therefore, for example, a comparatively lesser distance can be maintained on a multilane road in relation to a single-lane road between the motor vehicle and the preceding vehicle, in order to prevent the corrected distance between the motor vehicle and the preceding vehicle from being used by other road users on a multilane road in order to merge between the motor vehicle and the preceding vehicle.

The distance information can be determined by a vehicle-side radar device and the vehicle type information can be determined by a vehicle-side camera device. Particularly reliable determination of the distance information and the vehicle type information can therefore take place. The vehicle type information can be determined with the aid of software based on artificial intelligence on the basis of image data recorded by the camera device, for example, by means of object recognition.

The description above can be summarized as follows in other words and with respect to a specific embodiment, which is described as not limiting for the present disclosure: The background is the technical need for an increased distance behind trucks in adaptive cruise control (ACC) operation, intuitive driver behavior, and occasionally driving too close to a truck due to a regulation to the rear axle due to the height of trucks. It is known that adaptive distance control has already been implemented for other situations. The vehicle type truck has previously not been specially considered. This can cause driving too close due to regulation to the rear axle due to the height of trucks. The concept is that the vehicle type is recognized via the camera device, the distance is thereupon increased. This is based on an existing design of adaptive distance adjustment. A special partial factor is introduced here for following travel behind the vehicle type truck.

Furthermore, a computer program comprising commands which, upon the execution of the program by a computer, prompt it to at least partially execute or carry out the above-described method, is provided.

A program code of the computer program can be present in any code, in particular a code which is suitable for controllers of motor vehicles.

The description above with reference to the method also applies analogously to the computer program and vice versa.

Furthermore, a data processing device, such as a control unit, for an automated motor vehicle is provided, wherein the control unit is configured to at least partially execute or carry out the above-described method. The method is thus a computer-implemented method.

The data processing device can be part of a driver assistance system or can represent it. The data processing device can be, for example, an electronic control unit (ECU). The electronic control unit can be an intelligent processor-controlled unit which can communicate, for example, via a central gateway (CGW) with other modules and can form the vehicle onboard network, possibly via field buses, such as the CAN bus, LIN bus, MOST bus, and FlexRay or via automotive ethernet, for example together with telematics control units. It is conceivable that the control unit controls functions relevant for the driving behavior of the motor vehicle, such as the motor control, the force transmission, the braking system, and/or the tire pressure monitoring system. In addition, driver assistance systems, such as a parking assistant, an adaptive cruise control (ACC), a lane keeping assistant, a lane changing assistant, a traffic sign detector, a traffic signal detector, a startup assistant, a night view assistant, and/or an intersection assistant can be controlled by the control unit.

The description above with reference to the method and to the computer program also applies analogously to the data processing device and vice versa.

Furthermore, a motor vehicle comprising the above-described data processing device is provided.

The motor vehicle can be a passenger vehicle, in particular an automobile. The automated motor vehicle can be designed to at least partially and/or at least temporarily take over a longitudinal guidance and/or a lateral guidance during automated driving of the motor vehicle. The automated driving can take place so that the forward movement of the motor vehicle takes place (largely) autonomously. The automated driving can be controlled at least partially and/or temporarily by the data processing device.

The motor vehicle can be a motor vehicle of autonomy level 0, i.e. the driver takes over the dynamic driving task, even if assisting systems (such as ABS or ESP) are present.

The motor vehicle can be a motor vehicle of autonomy level 1, i.e. can have specific driver assistance systems which assist the driver in the vehicle operation, such as the adaptive cruise control (ACC).

The motor vehicle can be a motor vehicle of autonomy level 2, i.e. partially automated so that functions such as automatic parking, lane keeping or lateral guidance, general longitudinal guidance, acceleration, and/or deceleration can be taken over by driver assistance systems.

The motor vehicle can be a motor vehicle of autonomy level 3, i.e. conditionally automated so that the driver does not have to continuously monitor the system of the vehicle. The motor vehicle independently carries out functions such as triggering the turn signal, lane changing, and/or lane keeping. The driver can address other things but will be prompted by the system if needed within a prewarning time to take over the control.

The motor vehicle can be a motor vehicle of autonomy level 4, i.e. so highly automated that the control of the vehicle is permanently taken over by the system of the vehicle. If the driving tasks are no longer managed by the system, the driver can be prompted to take over the control.

The motor vehicle can be a motor vehicle of autonomy level 5, i.e. so fully automated that the driver is not necessary to fulfill the driving task. Except for defining the destination and starting the system, no human intervention is necessary. The motor vehicle can manage without steering wheel and pedals.

The description above with reference to the method, the data processing device, and the computer program also applies analogously to the motor vehicle and vice versa.

Furthermore, a computer-readable medium is provided, in particular a computer-readable storage medium. The computer-readable medium comprises commands which, upon the execution of the program by a computer, prompt it to at least partially execute the above-described method.

That is to say, a computer-readable medium can be provided which comprises an above-defined computer program. The computer-readable medium can be any digital data storage device, such as a USB stick, a hard drive, a CD-ROM, an SD card, or an SSD card. The computer program does not necessarily have to be stored on such a computer-readable storage medium in order to be provided to the motor vehicle, but rather can also be externally acquired via the internet or in another way.

The description above with respect to the method, the data processing device, the computer program, and the automated motor vehicle also applies analogously to the computer-readable medium and vice versa.

At least on embodiment is described hereinafter with reference to the Figures.

### BRIEF DESCRIPTION OF THE DRAWINGS

FIG. 1 schematically shows a motor vehicle according to one aspect of the invention and a preceding vehicle on a road; and

FIG. 2 shows a schematic flow chart of a method for adjusting a target distance between a motor vehicle and a preceding vehicle traveling in front according to one aspect of the invention.

### DETAILED DESCRIPTION OF THE DRAWINGS

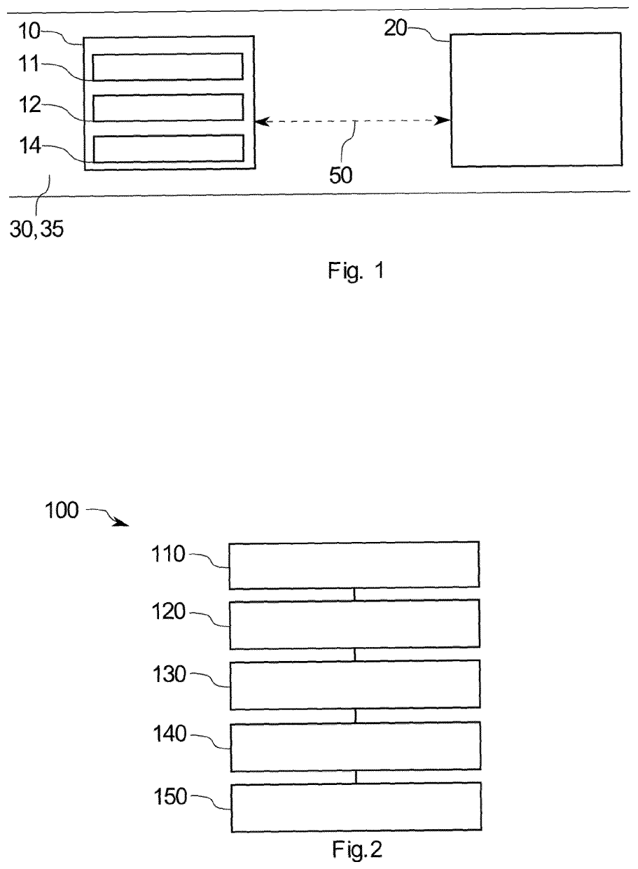

FIG. 1 schematically shows a motor vehicle 10 according to one aspect of the invention and a preceding vehicle 20 on a road 30.

The motor vehicle 10 and the preceding vehicle 20 are arranged on a schematically shown road 30, which is delimited by two horizontal lines. The road 30 has a lane 35. The motor vehicle 10 is a following vehicle with respect to the preceding vehicle 20. That is to say, the motor vehicle 10 moves in the direction of the preceding vehicle 20. A distance results between the motor vehicle 10 and the preceding vehicle 20 which, in the ideal case, corresponds to the target distance 50 represented by a double arrow having a dashed line. The target distance 50 is the distance between the motor vehicle 10 and the preceding vehicle 20 as set, for example, by the driver and/or in an automated manner.

The motor vehicle 10 is configured to carry out the method 100 described with reference to FIG. 2. For this purpose, the motor vehicle 10, as shown in FIG. 1, has a radar device 11, a camera device 12, and a data processing device 14.

The radar device 11 is configured and arranged to detect distance data or distance information in the surroundings of the motor vehicle 10 in the forward direction of the motor vehicle 10. The radar device 11 is configured to detect the distance between the motor vehicle 10 and the preceding vehicle 20.

The camera device 12 is configured and arranged to detect image data in the surroundings of the motor vehicle 10 in the forward direction of the motor vehicle 10. The camera device 12 is configured here to detect image data with respect to the preceding vehicle 20. The vehicle type of the preceding vehicle 20 and thus vehicle type information is determined from the image data. The vehicle type information indicates in particular whether the preceding vehicle 20 is a utility vehicle, thus, for example, a truck, a trailer of a truck, a bus, a van, or the like.

The motor vehicle 10 is therefore configured so that the distance information is determined 120 by the vehicle-side radar device 11, and that the vehicle type information is determined 130 by the vehicle-side camera device 12.

The data processing device 14 is configured to receive and process, among other things, data from the radar device 11 and the camera device 12, in order to determine and adjust the target distance 50. The data processing device 14 is configured to carry out a determination 140 of a correction distance on the basis of the distance information and the vehicle type information. The target distance 50 is adjusted 150 in such a way that the target distance 50 is increased if the vehicle type of the preceding vehicle 20 is a utility vehicle.

The determination 140 of the correction distance and the adjustment 150 of the target distance 50 is dependent on a speed of the motor vehicle 10. The speed of the motor vehicle 10 is the speed at which the motor vehicle 10 drives along the road 30. The determination 140 of the correction distance and the adjustment 150 of the target distance 50 is activated above an upper speed threshold and deactivated below a lower speed threshold.

The determination 140 of the correction distance and the adjustment 150 of the target distance 50 is dependent on a number of lanes 35 of the road 30 traveled by the motor vehicle 10. The determination 140 of the correction distance and the adjustment 150 of the target distance 50 is deactivated on a road 30 having multiple lanes 35. The determination 140 of the correction distance and the adjustment 150 of the target distance 50 remains activated on the road 30 having one lane 35 shown in FIG. 2.

FIG. 2 shows a schematic flow chart of a method 100 for adjusting a target distance 50 between a motor vehicle 10 and a preceding vehicle 20 traveling in front.

The motor vehicle 10, the preceding vehicle 20, and the target distance 50 are described with reference to FIG. 1.

The method 100 comprises the following steps: activating 110 an adaptive cruise control to adjust the target distance 50; determining 120 distance information characterizing the distance between the motor vehicle 10 and the preceding vehicle 20; determining 130 vehicle type information characterizing a vehicle type of the preceding vehicle 20; determining 140 a correction distance on the basis of the distance information and the vehicle type information; and adjusting 150 the target distance 50 on the basis of the correction distance.

A person skilled in the art recognizes in this case that the steps can have further substeps and in particular that the method steps can each be executed iteratively and/or in a different order. For example, the determination 120 of the distance information and the determination 130 of the vehicle type information can take place simultaneously. The determination 120 of the distance information and the determination 130 of the vehicle type information can also be carried out in a preparatory manner, thus beforehand.

### LIST OF REFERENCE NUMERALS

10 motor vehicle
11 radar device
12 camera device
14 data processing device
20 preceding vehicle
30 road
35 lane
50 target distance
100 method
110 activating an adaptive cruise control
120 determining distance information
130 determining vehicle type information
140 determining a correction distance
150 adjusting the target distance

1-10. (canceled)

11. A method for adjusting a target distance between a motor vehicle and a preceding vehicle traveling in front, comprising:
activating an adaptive cruise control to adjust the target distance;
determining distance information characterizing the distance between the motor vehicle and the preceding vehicle;
determining vehicle type information characterizing a vehicle type of the preceding vehicle;
determining a correction distance on the basis of the distance information and the vehicle type information; and
adjusting the target distance on the basis of the correction distance.

12. The method of claim 11, wherein the target distance is adjusted such that the target distance is increased if the vehicle type of the preceding vehicle is a utility vehicle.

13. The method of claim 11, wherein the determination of the correction distance and/or the adjustment of the target distance is dependent on a speed of the motor vehicle.

14. The method of claim 13, wherein the determination of the correction distance and/or the adjustment of the target distance is activated above an upper speed threshold and is deactivated below a lower speed threshold.

15. The method of claim 11, wherein the determination of the correction distance and/or the adjustment of the target distance is dependent on a number of lanes of a road travelled by the motor vehicle.

16. The method according of claim 15, wherein the determination of the correction distance and/or the adjustment of the target distance is deactivated on a road having multiple lanes.

17. The method of claim 11, wherein the distance information is determined by a vehicle-side radar device and the vehicle type information is determined by a vehicle-side camera device.

18. A computer program and/or computer-readable medium, comprising commands which, upon the execution of the program or the commands by a computer, prompt it to carry out the method and/or the steps of the method of claim 11.

19. A data processing device for an automated motor vehicle, wherein the data processing device is configured to carry out the method of claim 11.

20. A motor vehicle, comprising the data processing device of claim 19.
